(19) United States
(12) Patent Application Publication
(10) Pub. No.: US 2026/0086679 A1
(43) Pub. Date: Mar. 26, 2026

(54) Image-Based Display-to-Touch Interference Projection

(71) Applicant: Apple Inc., Cupertino, CA (US)

(72) Inventors: Myungjoon Choi, San Diego, CA (US); Jie Won Ryu, San Jose, CA (US); Manu Agarwal, Los Altos, CA (US); Sanjay Mani, Los Altos Hills, CA (US); Schuyler A. Tilney-Volk, San Francisco, CA (US); Peng Li, Cupertino, CA (US)

(21) Appl. No.: 19/337,632

(22) Filed: Sep. 23, 2025

Related U.S. Application Data
(60) Provisional application No. 63/699,716, filed on Sep. 26, 2024.

(51) Int. Cl. G06F 3/041; G06F 3/044; G09G 3/3233

(52) U.S. Cl. CPC G06F 3/0418; G06F 3/0412; G06F 3/04166; G09G 3/3233; G06F 3/044; G09G 2340/00; G09G 2354/00

(57) ABSTRACT

Systems, methods, and devices described herein may mitigate pixel and touch crosstalk noise. A touch system may compensate touch scan data to reduce the noise based on an estimated amount of switching-based display-touch crosstalk (switching DTX). Using the compensated touch scan data, the touch system may determine the proximity of a capacitive object to at least one touch sense region of the electronic display with improved signal to noise ratio.

### CROSS-REFERENCE TO RELATED APPLICATION

This application claims priority to U.S. Provisional Application No. 63/699,716, filed Sep. 26, 2024, entitled “Image-Based Display-to-Touch Interference Projection,” the disclosure of which is incorporated by reference in its entirety for all purposes.

### SUMMARY

The present disclosure relates generally to mitigating crosstalk between a display subsystem and a touch subsystem, and more specifically to mitigating undesired interference between the subsystems based on content displayed by the display subsystem.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (μLEDs). By causing different display pixels to emit different amounts of light, individual display pixels of an electronic display may collectively produce images.

An electronic display may include both a display subsystem and a touch subsystem, such as an integrated panel or system-on-a-chip (SOC). However, these subsystems may experience interference due to crosstalk between the two subsystems during operation. Examples of the crosstalk include switching-based display-touch crosstalk (switching DTX).

With switching DTX, a parasitic coupling path may be formed between a display pixel of the display subsystem and a touch receiver (RX) of a touch subsystem while image data is transmitted, which can increase noise in touch sensing signals based on values of the image data. switching DTX may involve display signals (e.g., gate waveforms) coupling to the touch receiver as display-to-touch noise. Thus, it may be desirable to compensate for crosstalk between the display subsystem and the touch subsystem, and in particular the switching DTX, that may occur between the display subsystem and touch subsystem. By doing so, touch scan data used in detecting where a tactile input was received on the display may be processed to remove the display-to-touch noise caused by the crosstalk to generate a relatively more accurate indication of the tactile input.

To compensate for switching DTX, image processing circuitry may calculate differences between voltage values within a display pixel for each row of the display image frame. The image processing circuitry may input the voltage values into a model to project (e.g., estimate, calculate, determine) inference caused by displaying the image content. The model may include parameters generated by test images and/or touch readings to model interference caused by displaying the image data. The touch subsystem may use the computed noise contribution to cancel out the switching DTX component from the touch sensing signals (e.g., touch scan data).

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a block diagram of a display pixel array of the electronic display of FIG. 1, in accordance with an embodiment;

FIG. 8 is a block diagram of a touch sensor array of the electronic display of FIG. 1, in accordance with an embodiment;

FIG. 9 is a circuit diagram representation of a portion of an electronic display of FIG. 1 that includes the display pixel array of FIG. 6 and the touch sensor array of FIG. 7, in accordance with an embodiment;

FIG. 10 is a graph illustrating a magnitude of display-touch noise over various touch receivers of the touch sensor array of FIG. 8, in accordance with an embodiment;

FIG. 11 is a block diagram of a portion of the electronic device of FIG. 1 including a touch subsystem operational based on a display noise engine and a display subsystem corresponding to the electronic display of FIG. 8, in accordance with an embodiment;

FIG. 12 is a graph illustrating projected display-to-touch noise and actual display-to-touch noise, in accordance with an embodiment;

FIG. 13 is a graph illustrating a demodulation signal applied to the projected display-to-touch noise, in accordance with an embodiment;

FIG. 14 is a graph illustrating a window function applied to the projected display-to-touch noise, in accordance with an embodiment;

FIG. 15 is a flowchart of an example method for mitigating display-to-touch noise by image processing circuitry, in accordance with an embodiment; and

FIG. 16 is a graph illustrating projected display-to-touch noise and actual display-to-touch noise after compensating for the switching DTX, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “one embodiment,” “an embodiment,” “embodiments,” and “some embodiments” of the present disclosure are not intended to be interpreted as excluding the existence of additional embodiments that also incorporate the recited features.

The present disclosure provides systems and methods for integrating a touch panel and a display panel into a single panel, which may reduce material costs, and to lower component footprints within an electronic display or device. For devices with integrated display and touch subsystems, special care may be taken to avoid crosstalk and noise between a touch subsystem and a display subsystem. Examples of the crosstalk include switching-based display-touch crosstalk (switching DTX), which may introduce undesired interference (e.g., display-to-touch noise) in touch sensing operations, increasing an inaccuracy of such operations.

Inaccurate touch sensing operations may lead to lagged response of the electronic device to the tactile input (e.g., from a user's touch, from a pencil or stylus device), performance of incorrect operations in response to the tactile input, undesirable results to occur in response to the tactile input, or the like. When undesired operations are performed in response to tactile inputs, computing resources may be spent performing the undesired operations, ending the undesired operations, or correcting the undesired operations in response to further received tactile input. Thus, it may be desirable to mitigate the switching DTX in touch scan data captured before the tactile input is determined from the touch scan data to improve accuracy of touch sensing operations. Improving accuracy of touch sensing operations may lead to improved user experience with the electronic device and/or improved electronic device performance through reducing a likelihood of inefficient allocation of computing resources.

Keeping the foregoing in mind, described herein are systems and methods that may mitigate effects of switching DTX to improve user experience and device performance. Indeed, the systems and methods may receive indications of the image data associated with the switching DTX to determine and remove an amount of error expected to alter touch scan data. By removing the expected error from the touch scan data, the systems and methods may compensate for the crosstalk.

To compensate for the switching DTX, image processing circuitry (e.g., processing circuitry) may send a gate clock, content dependent voltage information, pixel current, pixel reference voltages (e.g., anode reset voltage, ELVSS), and the like to the touch subsystem. The model may include parameters corresponding to a noise contribution from a gate clock signal when presenting the image frames, a demodulation signal, a window function, and so on. Since switching DTX may increase (e.g., worsen) as voltage differences between rows increase, indications of these signals may be used to predict an estimated switching DTX as a computed noise signal to be used to compensate for the switching DTX. The estimated switching DTX may be used as a baseline of an expected amount of noise (e.g., display-to-touch noise) from which the noise removal operations can better remove actual noise in touch scan data. By removing the actual noise from the touch scan data based on expected noise, the systems and methods may compensate for crosstalk from switching DTX, thereby improving device operations, such as touch sensing operations.

Compensating for display pixel-touch crosstalk (e.g., switching DTX) may improve device operation. For example, an electronic device compensating for the crosstalk may improve performance of the touch subsystem and/or may reduce an amount of power consumed by the touch subsystem by mitigating interference associated with the crosstalk. These compensation techniques also may enable greater touch frequency operation. A wide variety of electronic display and tactile input devices may benefit from these operations described herein since these compensation operations may be deployed across a wide range of devices including phones, tablets, watches, desktops, and even other displays with integrated touch and display panels. Moreover, touch performance of the display panel may be quantified by comparing performance while the operations are performed versus while the operations are not performed. This may enable selective use of the crosstalk compensation operations and further power reductions by compensating for the crosstalk when most appropriate. For example, crosstalk compensation operations may be performed in response to particularly noisy data expected or scheduled to be displayed, in response to periodic timelines or schedules, in response to an input via an input device, or other suitable inputs or signals to trigger performance of the crosstalk compensations.

The described systems and methods may be used by any device with a relatively tight integration of display and touch subsystems, such as displays with in-cell or on-cell touch. Furthermore, these described systems and methods may be different from other crosstalk compensation systems (e.g., traditional crosstalk compensation systems), as other crosstalk compensation systems may not use display current aggregation methods when compensating for switching DTX.

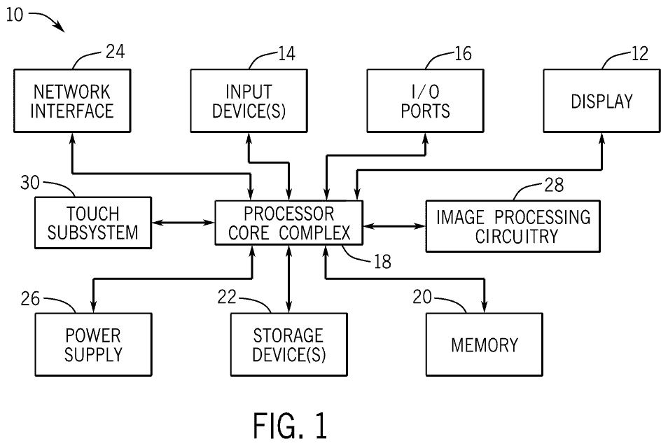

To help illustrate, an example of an electronic device 10, which includes and/or utilizes an electronic display 12, is shown in FIG. 1. As will be described in more detail below, the electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

In addition to the electronic display 12, as depicted, the electronic device 10 includes one or more input devices 14, one or more input/output (I/O) ports 16, a processor core complex 18 having one or more processors or processor cores, main memory 20, one or more storage devices 22, a network interface 24, a power supply 26, image processing circuitry 28, and a touch subsystem 30. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the main memory 20 and a storage device 22 may be included in a single component. In another example, the image processing circuitry 28 may be included in the processor core complex 18 or the electronic display 12. As described herein, the image processing circuitry 28 may be part of a display subsystem that may be integrated with the touch subsystem 30 and within the electronic display 12 or on a system-on-a-chip (SOC) separate from the electronic display 12.

As depicted, the processor core complex 18 is operably coupled with main memory 20 and the storage device 22. As such, in some embodiments, the processor core complex 18 may execute instructions stored in main memory 20 and/or a storage device 22 to perform operations, such as generating image data. Additionally or alternatively, the processor core complex 18 may operate based on circuit connections formed therein. As such, in some embodiments, the processor core complex 18 may include one or more general purpose microprocessors, one or more application specific processors (ASICs), one or more field programmable logic arrays (FPGAs), or any combination thereof.

In addition to instructions, in some embodiments, the main memory 20 and/or the storage device 22 may store data, such as image data. Thus, in some embodiments, the main memory 20 and/or the storage device 22 may include one or more tangible, non-transitory, computer-readable media that store instructions executable by processing circuitry, such as the processor core complex 18 and/or the image processing circuitry 28, and/or data to be processed by the processing circuitry. For example, the main memory 20 may include random access memory (RAM) and the storage device 22 may include read only memory (ROM), rewritable non-volatile memory, such as flash memory, hard drives, optical discs, and/or the like.

As depicted, the processor core complex 18 is also operably coupled with the network interface 24. In some embodiments, the network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a 4G or LTE cellular network. In other words, in some embodiments, the network interface 24 may enable the electronic device 10 to transmit data (e.g., image data) to a communication network and/or receive data from the communication network.

Additionally, as depicted, the processor core complex 18 is operably coupled to the power supply 26. In some embodiments, the power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter.

Furthermore, as depicted, the processor core complex 18 is operably coupled with one or more I/O ports 16. In some embodiments, the I/O ports 16 may enable the electronic device 10 to interface with another electronic device 10. For example, a portable storage device may be connected to an I/O port 16, thereby enabling the electronic device 10 to communicate data, such as image data, with the portable storage device.

As depicted, the processor core complex 18 is also operably coupled with one or more input devices 14. In some embodiments, an input device 14 may enable a user to interact with the electronic device 10. For example, the input devices 14 may include one or more buttons, one or more keyboards, one or more mice, one or more trackpads, and/or the like. Additionally, in some embodiments, the input devices 14 may include touch sensing components implemented in the electronic display 12. In certain instances, the touch subsystem 30 may include the touch sensing components implemented in the electronic display 12 to receive user inputs by detecting occurrence and/or position of an object contacting the display surface of the electronic display 12.

In certain instances, the image processing circuitry 28 may be implemented within the processor core complex 18 and perform functions such as adjusting image data for display on the electronic display 12. In addition to enabling user inputs, the electronic display 12 may facilitate providing visual representations of information by displaying one or more images (e.g., image frames or pictures). For example, the electronic display 12 may display a graphical user interface (GUI) of an operating system, an application interface, text, a still image, or video content. To facilitate displaying images, as will be described in more detail below, the electronic display 12 may include a display panel with one or more display pixels.

As described above, an electronic display 12 may display an image by controlling luminance of its display pixels based at least in part on image data associated with corresponding image pixels (e.g., points) in the image. In some embodiments, image data may be generated by an image source, such as the processor core complex 18, a graphics processing unit (GPU), and/or an image sensor. Additionally, in some embodiments, image data may be received from another electronic device 10, for example, via the network interface 24 and/or an I/O port 16. In any case, as described above, the electronic device 10 may be any suitable electronic device.

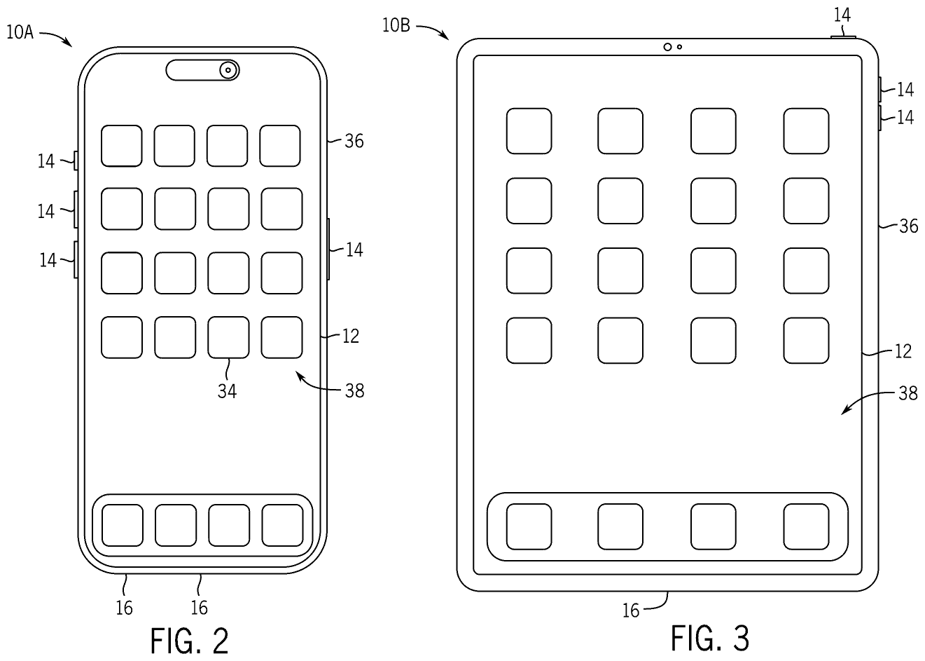

To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For example, the handheld device 10A may be a smart phone, such as any iPhone® model available from Apple Inc.

As depicted, the handheld device 10A includes an enclosure 36 (e.g., housing). In some embodiments, the enclosure 36 may protect interior components from physical damage and/or shield them from electromagnetic interference. Additionally, as depicted, the enclosure 36 surrounds the electronic display 12. In the depicted embodiment, the electronic display 12 is displaying a graphical user interface (GUI) 38 having an array of icons 34. By way of example, when an icon 34 is selected either by an input device 14 or by a component of the touch subsystem 30 of the electronic display 12, an application program may be launched.

Furthermore, as depicted, input devices 14 open through the enclosure 36. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. As depicted, the I/O ports 16 also open through the enclosure 36. In some embodiments, the I/O ports 16 may include, for example, an audio jack to connect to external devices.

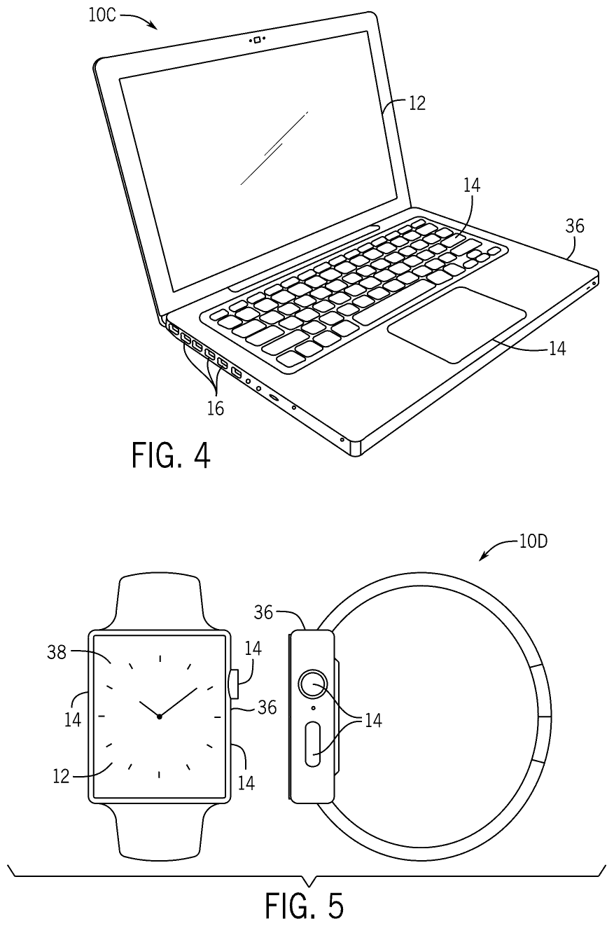

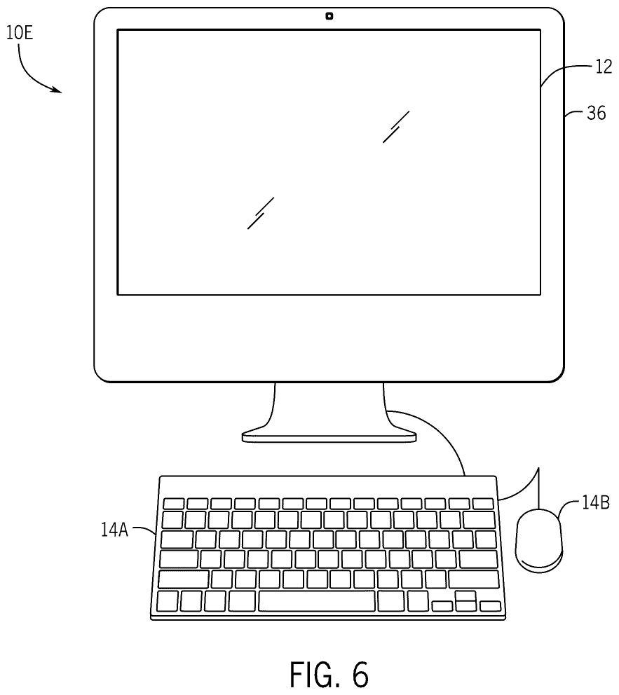

To help further illustrate, another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be an Apple Watch® model available from Apple Inc. As depicted, the tablet device 10B, the computer 10C, and the watch 10D each also includes an electronic display 12, input devices 14, I/O ports 16, and an enclosure 36. In any case, as described above, an electronic display 12 may generally display images based at least in part on image data, for example, output from the processor core complex 18 and/or the image processing circuitry 28. To help illustrate, an example of the electronic display 12 of an electronic device 10, is shown in FIG. 6.

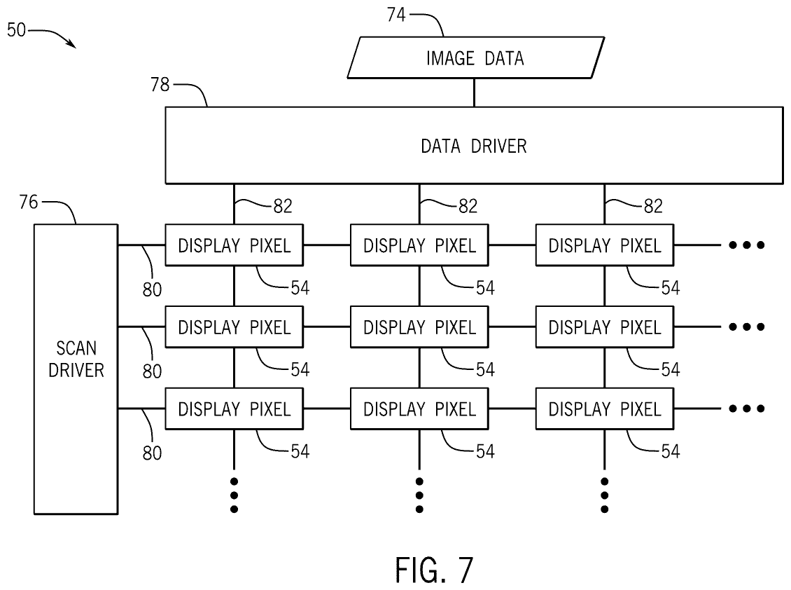

Keeping the foregoing in mind, FIG. 7 is a block diagram of a display pixel array 50 (e.g., display subsystem) of the electronic display 12. It should be understood that, in an actual implementation, additional or fewer components may be included in the display pixel array 50.

The electronic display 12 may receive image data 74 for presentation on the electronic display 12. The electronic display 12 includes display driver circuitry that includes scan driver circuitry 76 and data driver circuitry 78. The display driver circuitry controls programing the image data 74 into the display pixels 54 for presentation of an image frame via light emitted according to each respective bit of image data 74 programmed into one or more of the display pixels 54.

The display pixels 54 may each include one or more self-emissive elements, such as a light-emitting diodes (LEDs) (e.g., organic light emitting diodes (OLEDs) or micro-LEDs (μLEDs)), however other pixels may be used with the systems and methods described herein including but not limited to liquid-crystal devices (LCDs), digital mirror devices (DMD), or the like, and include use of displays that use different driving methods than those described herein, including partial image frame presentation modes, variable refresh rate modes, or the like.

Different display pixels 54 may emit different colors. For example, some of the display pixels 54 may emit red (R) light, some may emit green (G) light, and some may emit blue (B) light. The display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use cyan (C), magenta (M), or others.

The scan driver circuitry 76 may provide scan signals (e.g., pixel reset, data enable, on-bias stress, emission enable) on scan lines 80 to control the display pixels 54 by row. For example, the scan driver circuitry 76 may cause a row of the display pixels 54 to become enabled to receive a portion of the image data 74 from data lines 82 from the data driver circuitry 78. In this way, an image frame of image data 74 may be programmed onto the display pixels 54 row by row. Other examples of the electronic display 12 may program the display pixels 54 in groups other than by row. In another example, the scan driver circuitry 76 may perform other operations, such as causing an anode reset voltage to be applied to an anode from time to time, causing data switching, and so on. During an anode reset, for example, the scan driver circuitry 76 may instruct a switch to close and the anode voltage (VAR) to be applied to an anode. The scan driver circuitry 76 may apply the anode reset to anodes of the electronic display 12 (which may correspond to the rows of display pixels 54) starting from a first row of the display pixels 54 proximate to a first edge of the electronic display 12 to a last row of the display pixels 54 proximate to an opposite edge of the electronic display 12. For example, the scan driver circuitry 75 may transmit an anode reset signal, which may be a rolling signal, that moves up or down the electronic display 12 in a sequential manner and causes an anode voltage to be applied to a respective anode corresponding to the row of display pixels 54.

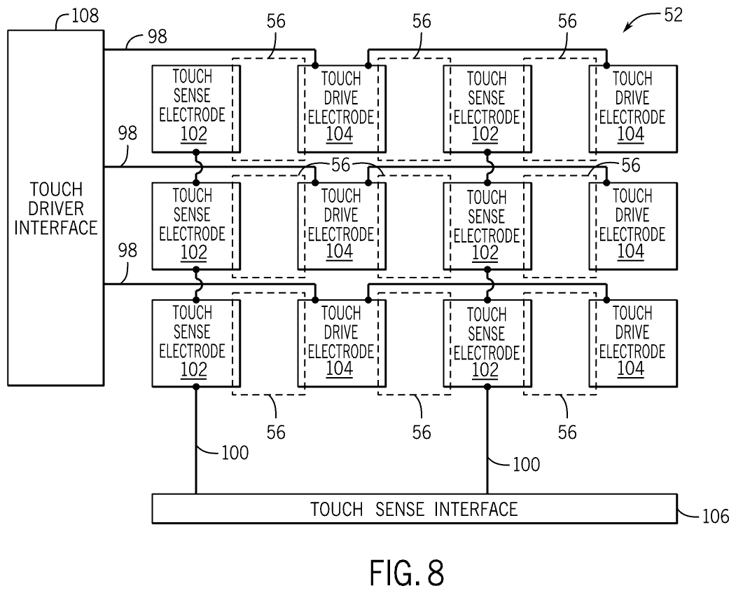

The display pixel array 50 operates differently than the touch sensor array 52 but may share some of the same electrical components with and/or may be in very close proximity to the touch sensor array 52. Referring now to operations of the touch sensor array 52, FIG. 8 is a block diagram of the touch sensor array 52 of the electronic display 12. The touch sensor array 52 may be controlled by the touch subsystem 30. Additionally or alternatively, the touch sensor array 52 and the display pixel array 50 may be integrated and disposed onto a same component, a silicon chip, a board, or the like. For example, electrodes used by the touch sensor array 52 may be formed from components (e.g., cathodes, anodes, power rails, conductive mask material) also used by the display pixel array 50.

The touch sensor array 52 includes a matrix of touch sense regions 56 formed by interactions between touch drive electrodes 104 driven via conductive lines 98 and touch sense electrodes 102 sensed via conductive lines 100. It should be noted that the terms “lines” and “electrodes” as sometimes used herein simply refer to conductive pathways and are not intended to be limited to structures that are strictly linear. Rather, the terms “lines” and “electrodes” may encompass conductive pathways that change direction or that have different size, shape, materials, or regions. The touch sense electrodes 102 may be sensed along conductive lines 100 by a touch sense interface 106 while different rows of touch drive electrodes 104 are driven with touch drive signals along the conductive lines 98 from a touch driver interface 108. For example, the touch drive signals may be driven from a first conductive line 100 adjacent to a first edge of the electronic display 12 to a last conductive line 100 adjacent to an opposite edge of the electronic display 12 in a sequential manner over time. As referred to herein “integration time” may correspond to times during which the capacitance may be sensed by the touch sensor array 52 and/or the touch subsystem 30.

The touch sense electrodes 102 may respond differently to the touch drive signals based on a proximity of an object, such as a finger or a pencil or stylus, to the touch sense electrodes 102. In this way, the presence of the object may be “seen” in a touch sense region 56 that may result at an intersection of the touch drive electrode 104 and the touch sense electrode 102. That is, the touch drive electrodes 104 and the touch sense electrodes 102 may form capacitive sensing nodes, or more aptly, the touch sense regions 56. The touch sense electrodes 102 and touch drive electrodes 104 may gather touch sense information when operating in what may be referred to herein as a touch mode of operation.

Though the touch sense electrodes 102 and the touch drive electrodes 104 may be supplied the same or substantially similar direct current (DC) bias voltage, different alternating current (AC) voltages may be supplied and/or received on touch sense electrodes 102 and touch drive electrodes 104 at substantially different times in some embodiments. For example, the electronic display 12 may switch between two modes of operation: a display mode of operation and a touch mode of operation. Furthermore, in some touch sensor arrays 52, an AC reference voltage is used as ground for the touch sensing operations associated with the touch sensor array 52.

As noted above, challenges arise when combining the display pixel array 50 and the touch sensor array 52 in an integrated touch and image panel. By nature of touch sensors (e.g., touch sense regions 56) being in relatively close proximity to (or formed in part by components of) the display pixels 54, some electromagnetic interference may arise between the display pixel array 50 and the touch sensor array 52. In certain instances, a timing of the anode reset signal may result in a content-dependent residual anode voltage remaining on the anodes of certain rows of display pixels 54 more than other rows of display pixels 54, the resulting variation of which may be detected by the touch sense electrodes 102. Without correction, these variations could appear to be spurious touch signals in the form of switching DTX between the two subsystems.

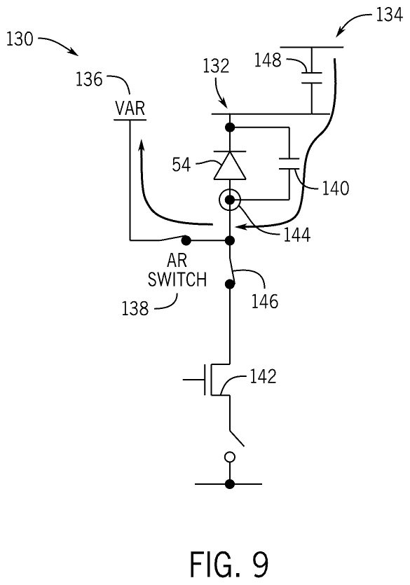

FIG. 9 is a circuit diagram 130 representation of a portion of an electronic display 12 with an integrated touch and image panel. By way of example, the display pixel array 50 and the touch sensor array 52 may share electrodes during operation. For example, the electrodes may include cathodes and anodes that may be used by the display pixel array 50 during a display mode of operation and subsequently used by the touch sensor array 52 during a touch mode of operation. The display pixel array 50 and the touch sensor array 52 may be capacitively coupled, and because of the coupling, some electromagnetic interference may arise between the display pixel array 50 and the touch sensor array 52, as further described below. Additionally or alternatively, the display driver (e.g., the scan driver circuitry 76, the data driver circuitry 78) may be integrated with the touch sense interface 106 and the touch driver interface 108 (referred to herein as “combined touch and display driver”).

For purposes of discussion, FIG. 9 illustrates a simplified example of a cathode 132 coupled to a display pixel 54, a touch receiver 134 (e.g., touch sense region 56), and an anode reset voltage (VAR) 136 via an anode reset switch 138. In this example, the display pixels 54 include OLED devices, however the display pixels 54 may include any suitable light-emitting device or self-emission component. Each display pixel 54 may have a parasitic capacitance 140 over which transient charge may flow. A transistor 142 may be considered a current source. The electrical current may vary depending on a programming voltage on the gate of the transistor 142 and may be provided through a switch 146. An anode voltage on a node 144 may vary based on the current flowing over the display pixel 54, which is itself based on the voltage applied to a gate of the driving transistor, which is based on the image data. In other words, the anode voltage at the node 144 may vary depending on the content that the display pixel 54 is displaying.

In the display mode of operation, the combined touch and display driver (e.g., scan driver circuitry 72) may implement an anode reset operation. For example, the combined touch and display driver may adjust and/or reset the voltage applied to the display pixels 54 using the anode reset voltage (VAR) 136 (reset voltage added to an anode of a display pixel 54) to return the anode to a consistent voltage, since the voltage on the anode at the node 144 may shift over time due at least in part on the current being applied across the display pixel 54. In this way, the anode voltage at the node 144 may change over time due to the image content being displayed by the display pixel 54. By periodically resetting the anode voltage at the node 144, the behavior of the display pixel 54 may be made more consistent.

The VAR 136 may be related to the turn on voltage for the display pixel 54. An AR switch 138 may selectively provide the VAR 136 to the anode coupled to the display pixel 54. The AR switch 138 may take the form of any suitable transistor (e.g., LTPS or LTPO PMOS, NMOS, or CMOS transistors). For example, the combined touch and display driver may instruct the AR switch 138 to close, which may apply the VAR 136 to the display pixel 54 for the anode reset operation. The combined touch and display driver may implement the anode reset operation for each anode (e.g., anode or anodes of a row of display pixels 54) in a sequential manner (e.g., via a rolling signal), such as implementing the anode reset operation on a first anode or set of anodes, followed by a second anode or set of anodes, followed by a third anode or set of anodes, and so on.

As mentioned above, the anode voltage at the node 144 may shift due in part to the content on the display pixel 54. Thus in certain instances, the anode reset operation may result in a change to voltage at node 144, such as an increase or decrease in voltage. The change in voltage on the anode at the node 144 may result in a transient signal traversing the parasitic capacitance 140 and thus to a parasitic capacitance from the cathode 132 to the touch receiver 134 and/or the input of the touch receiver 134.

In the touch mode of operation, the combined touch and display driver (e.g., the scan driver circuitry 76 or the data driver circuitry 78) may generate a stimulus voltage for the cathode 132 while sampling of tactile inputs to the display by the touch receiver 134. The touch receiver 134 may detect an object based on a change in capacitance. The stimulus voltage may include a narrowband waveform, a sine wave, or any suitable alternating current (AC) voltage. The combined touch and display driver may generate and send the stimulus voltage from a voltage generator through a touch transmit path to the touch receiver 134. The touch receiver 134 may include a capacitor 148 and/or a capacitive sensing node that performs touch sensing operations, such as sensing for a touch during integration time. The capacitor 148 may detect a charge that changes based on a proximity of the object to the touch receiver 134 and/or the touch sense electrodes 102. As the object moves closer to the touch receiver 134, for example, the more that charge on the capacitance of the capacitor 148 may change. After receiving the stimulus voltage, a touch sensor, such as the touch receiver 134, may generate a current in response to the stimulus voltage being received while a tactile input is received. A portion of the current may transmit from the touch receiver 134 to a touch receive path, where the current may be sensed by the touch subsystem 30 and used to generate an indication of a tactile input. It may be understood that the display mode of operation and the touch mode of operation may be performed by the combined touch and display driver at the same time or similar times.

In certain instances, parasitic capacitances may form between the display subsystem and the touch subsystem 30. For example, during operation in the display mode of operation switching DTX may occur, which may affect the behavior of the touch receiver 134. For example, a parasitic coupling path between the VAR 136 and the touch receiver 134 may cause sensed capacitance values to change in relation to noise (e.g., display-to-touch noise (DTN)). During the display mode of operation, for example, the anode reset operation may result in a change to the voltage at the node 144, which may change the voltage of the touch receiver 134 during touch sensing. The combined touch and display driver (e.g., touch subsystem 50) may measure the amount of voltage of the touch receiver 134 to determine touch and/or proximity of an object. The amount of voltage of the touch receiver 134 may be equivalent to the sum of the stimulus voltage and the residual voltage at the node due to the anode reset operation. As such, the touch receiver 134 may receive a combined voltage of the stimulus voltage generated by the combined display/touch driver (e.g., display driver integrated with the touch sense interface 106 and the touch driver interface 108) and residual voltage at the node 144 from the display mode of operation (e.g., anode reset). The resulting error may affect the capacitance sensed during touch sensing operations. Thus, compensating for switching DTX may improve the performance of touch sensing operations in the electronic display 12.

To do so, an electronic device 10 may determine an estimated amount of switching DTX and generate a computed noise signal (e.g., compensation signal) that enables the touch subsystem 30 to remove the noise from the touch scan data based on the estimated amount of switching DTX. The estimated amount of switching DTX may be determined based on statistics associated with an image frame to be presented, functions and/or signals applied by the touch subsystem 30, pre-determined calibration parameters, and so on. Once switching DTX is estimated, the electronic device 10 (e.g., the image processing circuitry 28) may remove noise from touch scan data by subtracting the estimated switching DTX from the touch scan data. In some systems, the electronic device 10 may remove noise through “seeding” a processing operation with the estimated amount of switching DTX, which may improve a determination of an actual amount of switching DTX in touch scan data and make such determination more accurate. By using systems and methods described above, like the subtracting methods or “seeding” methods, a signal-to-noise ratio may improve when switching DTX is compensated for in the touch scan data.

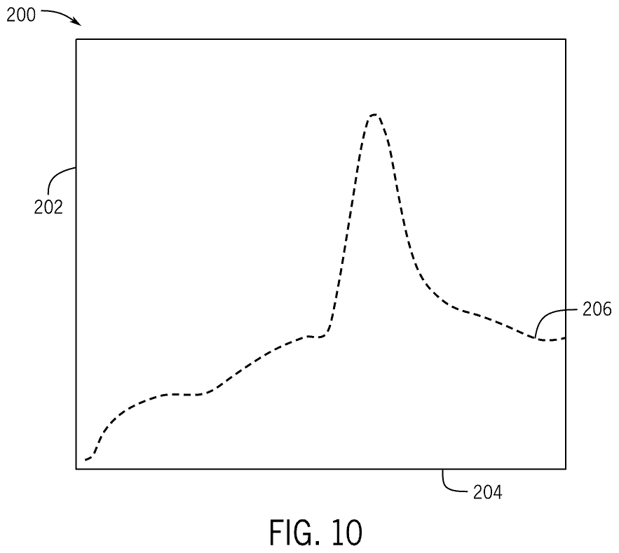

FIG. 10 is a graph 200 illustrating a magnitude of measured switching DTX over various touch receivers 134 of the touch sensor array 52. The switching DTX may be measured from image content displayed on the electronic display 12. The graph 200 compares a magnitude of switching DTX values (axis 202) to a position of the touch receivers (axis 204) positioned in different rows of the electronic display 12. For example, a row number of the touch receivers within the electronic display 12 may increase from left to right along the axis 204.

For example, the graph 200 includes a line 206 corresponding to measured switching DTX for image data displayed by the display pixels 54. A magnitude of the switching DTX may be based on the image data being displayed on the electronic display 12. As illustrated, the magnitude of the switching DTX may be non-linear and include a single peak or multiple spatial peaks. In certain instances, the waveform illustrated by line 206 may correspond to a waveform corresponding to capacitance changes to the capacitor 148 of the touch receiver 134 caused by a touch to the electronic display 12.

During the display mode of operation, the combined touch and display driver may drive the display pixels 54 to display the frame of image data and also perform an operation, such as anode reset, data line switching, display data switching, and so on. For example, the combined touch and display driver may instruct resetting of voltage on a first anode (e.g., a first row of display pixels 54) proximate to a first edge of the electronic display 12 and resetting of voltage on each subsequent anode of the electronic display 12. Concurrently or around the same time, the combined touch and display driver may perform a touch sensing operation during the touch mode of operation. For example, the touch operation may start at a last row of touch receivers 134 (e.g., opposite to the first row of display pixels 54) and continue for each subsequent row of touch receivers 134. In another example, the touch operation may perform the touch sensing operation using any suitable umber of touch receivers 134. In another example, a timing of the anode reset signal may overlap with a timing of the touch sensing signal. As such, the touch sensing operation and the display operation may overlap at one or more anodes (e.g., rows of display pixels 54), resulting in an increase in the magnitude of the switching DTX in comparison to when the touch operation and the anode reset operation are not overlapping. As illustrated in the graph 200, switching DTX may peak at a center position of the touch receivers 134 (axis 204) or around rows 35 to 37 of the electronic display 12. After the overlap, the magnitude of the switching DTX may decrease, which may indicate that the timing of the anode reset signal may not overlap with the timing of the touch sensing signal.

The graph 200 may be used to determine parameters (e.g., values, coefficients) for a model used to compensate for switching DTX. For example, constant values for each color channel, constant values for each row of the electronic display 12, constant values for each column of the electronic display 12, or any combination thereof may be determined based on the graph 200. Additionally or alternatively, knowledge of image data to be displayed may be used to algorithmically remove the switching DTX from the touch scan data. For example, the image data 74 may be inputted into the model to project the magnitude of switching DTX caused by displaying the image data and use the magnitude to remove the capacitance noise (e.g., display-to-touch noise, switching DTX) from the touch scan data.

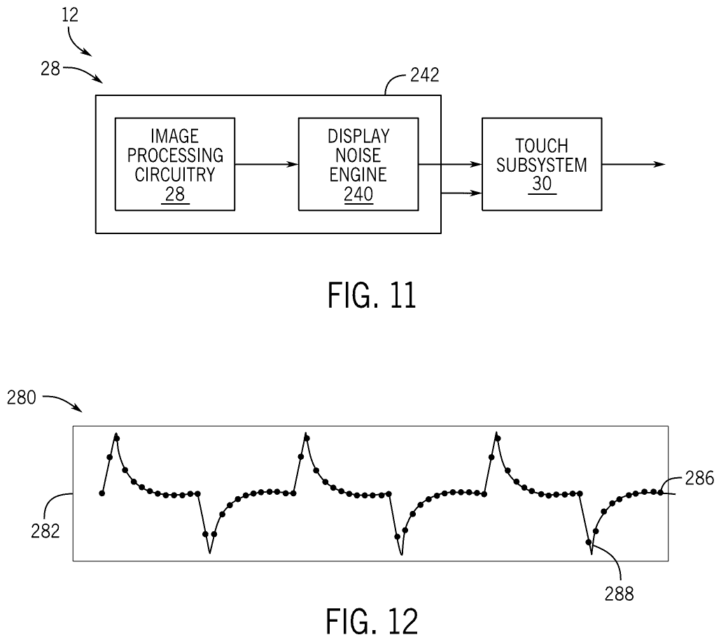

FIG. 11 is a block diagram of a portion of the electronic device 10 including the image processing circuitry 28, a display noise engine 240, and a touch subsystem corresponding to the electronic display 12. In certain instances, a system-on-chip (SOC) 242 (e.g., the processor core complex 18) may implement the image processing circuitry 28 and the display noise engine 240. Additionally or alternatively, the image processing circuitry 28 and the display noise engine 240 may be implemented by a display driver integrated circuit (DDIC) and the SOC 242 may implement the touch subsystem 30. In other instances, the SOC 242 may implement the image processing circuitry 28, the display noise engine 240, and the touch subsystem 30.

The combined touch and display driver (e.g., the data driver circuitry 78) may generate display scan data based on the image data 74, which may transmit via an output first-in, first-out buffer to the integrated image and touch display. The combined touch and display driver may transmit sync information and gate clocking signal (e.g., information) directly to the touch subsystem 30. While the integrated image and touch display is preparing and transmitting the touch scan data, image processing circuitry 28 may input at least a portion of the image data 74 to the display noise engine 240 to project an estimated switching DTX. For example, the image frame may be presented via the electronic display 12 during a partially overlapping time to a touch scan used to detect where, relative to the display 12, a tactile input is received. Indeed, at least a portion of the image data 74 corresponding to the image frame may be received and/or generated as the image data 74 before the image frame is presented via the display 12. As such, determining and compensating for displaying the image content may improve touch sensing operations.

To compensate for switching DTX, the image processing circuitry 28 may input at least a portion of the image data 74 to the display noise engine 240 to project the interference caused by the switching DTX (e.g., display-to-touch noise (DTN)) experienced by the touch subsystem 30. For example, the display noise engine 240 may determine the magnitude of the switching DTX and generate a computed noise signal that enables the touch subsystem 30 to adjust the touch scan data to compensate for the switching DTX. To this end, the display noise engine 240 may include a model (e.g., DTN model based on understanding of DTN mechanisms) that predicts switching DTX from the image data 74 represented by row-to-row data and sync information (e.g., gate clock information and/or additional sync data). As discussed herein, the model may be generated based on information from the graph 200 illustrated in FIG. 10. The model may include parameters corresponding to noise generated by the color channel, noise generated per row of the electronic display 12, noise generated based on or more rows of the electronic display 12, or any combination thereof. For example, the model may include a matrix of coefficients corresponding to each color channel and/or each row of the electronic display 12, and thus each value of the image data 74. The model may also include parameters corresponding to noise generated by a gate clock signal when presenting different image frames. The parameters, for example, may be determined based on test images and/or touch images to provide production and/or calibration of the model.

The image processing circuitry 28 may convert the image data 74 from gray level to voltage values as part of a gray-to-voltage (G2V) conversion operation. The values of the row may be consolidated by averaging among the values of the rows to generate a single value (e.g., a weighted average). The image processing circuitry 28 may determine the difference between the pixel voltage and the anode reset voltage. The image processing circuitry 28 may generate and/or store the difference as a vector matrix for input into the display noise engine 240. For example, the image processing circuitry 28 may aggregate the voltage values per row over an integration time at a row where integration starts. The image processing circuitry 28 may input the voltage values into the model along with gate clock, content dependent data line toggling information, pixel current, pixel reference voltages, and the like to project the estimated switching DTX. For example, the model may output a magnitude (e.g., waveform, profile) of the estimated switching DTX based on the image data.

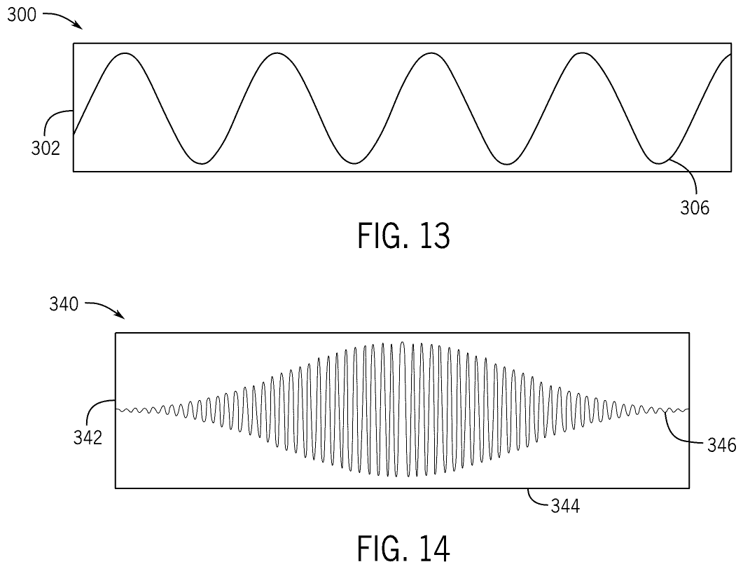

In certain instances, the voltage values of rows may be weighted-summed to generate the estimated switching DTX. For example, each display row transition may map to a number of touch samples that may be taken during the touch mode of operation. The model may determine an aggregated switching DTX for a channel based on the estimated switching DTX, a demodulation signal, and a window function over the integration time. The demodulation signal may include a noise waveform proportional to a change in voltage. As will be further described with respect to FIG. 13, the demodulation function may correspond to a respective row of the electronic display. For example, a first demodulation signal may be applied for a first channel, a second demodulation signal may be applied for a second channel, and so on. The window function may include a value within a chosen interval and may be approximately zero outside of the chosen interval. As will be further described with respect to FIG. 14, the window function may include a value within a chosen interval that corresponds to a peak magnitude of switching DTX and be approximately zero outside of the chosen internal. The model may determine interference from switching DTX from a row transition by aggregating the estimated switching DTX, the demodulation signal, and the window function after the integration time. At a particular row, the waveform of the switching DTX may be proportional to a change in voltage. For example, the model may determine the interference from the switching DTX for a particular row based on the change in voltage (e.g., of the image data 74 corresponding to the row) and the aggregate of a parameter (e.g. constant), the demodulation signal, the window function after the integration time. As such, the model may determine the interference from the switching DTX per row to a first order using a weighted-sum parameter.

The systems and methods described herein use determinations over regions, such as cells, columns, or rows, of data. Although some operations described here reference operations performed to each cell or each row, it should be understood that these operations may be applied to regions of data or regions of the integrated image and touch display. For example, the display noise engine 240 may include a lump-summed parameter per display row to adjust a region of rows or a region of columns. Additionally or alternatively, a region of rows, a region of columns, or both may be used to determine the row-to-row display pixel anode voltage variations in data, such as two-to-two row changes, three-to-three row changes, or the like. This may include averaging image data, gray level data, voltage values determined based on the image data, current values determined based on the image data, or the like, between columns of respective rows, then using the averaged row data to determine the total display pixel anode voltage variation data or resulting current changes for two or more rows.

FIG. 12 illustrates a graph 280 displaying a waveform of the switching DTX between the touch subsystem and the display subsystem. For example, axis 282 illustrates a magnitude of switching DTX in Volts. The graph 280 illustrates projected display noise (illustrated by dots 286) and actual display noise (illustrated by line 288). The projected display noise (e.g., estimated switching DTX) may be estimated and/or determined by the display noise engine 240 based on a frame of image data 74. The actual display noise (e.g., measured switching DTX) may be determined by displaying the frame of image data on the electronic display 12 and measuring the noise generated by displaying the frame of image data 74. As illustrated, the projected display noise and the actual display noise overlap significantly, which illustrates the accuracy of the display noise engine 240 projecting switching DTX based on the image data 74 and the model.

FIG. 13 illustrates a graph 300 displaying a magnitude of the demodulation signal (axis 302). The display noise engine 240 may apply the demodulation signal (illustrated by line 306) to generate the compute noise signal using a lumped-summed parameter. As illustrated, the demodulation signal may include a sine wave, a cosine wave, or any suitable waveform. For example, the demodulation signal applied by the display noise engine 240 may match a demodulation signal applied by the touch subsystem 30 during touch sensing operations. In another example, the touch subsystem 30 may apply a demodulation signal to touch scan data to determine a signal corresponding to tactile input and/or remove the signal from a modulated carrier signal.

FIG. 14 illustrates a graph 340 displaying a magnitude of the window function (axis 342) over interference from switching DTX (axis 344). In certain instances, interference from switching DTX may peak due to the display operations overlapping with the touch sensing operations at center a position of the electronic display 12. To compensate for the interference, the window function (illustrated by line 346) may include a value within a chosen interval and may include a value approximately equal to zero outside of the chosen interval. In certain instances, the touch subsystem 30 may apply the window function during touch sensing operations and the illustrated window function may match the window function applied by the touch subsystem 30.

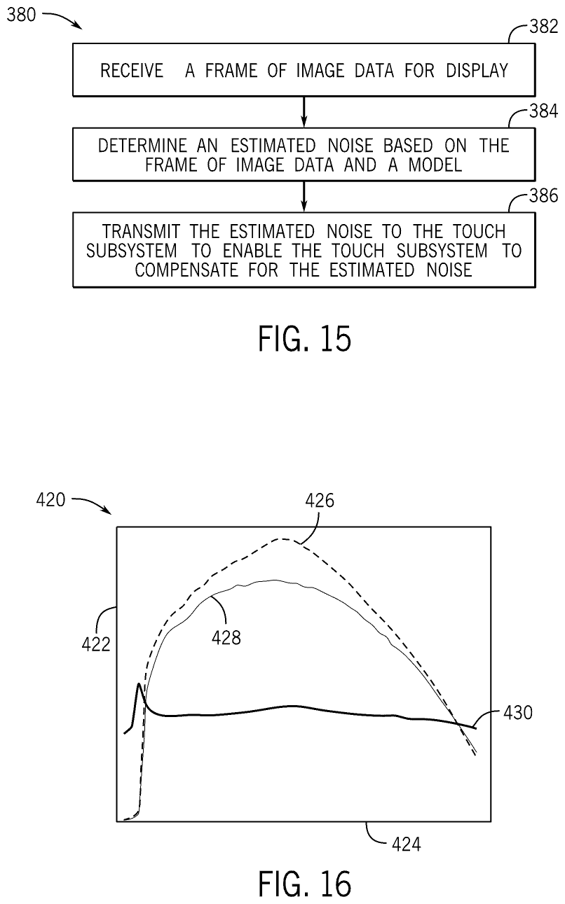

FIG. 15 is a flowchart of an example method 380 for mitigating display noise by the image processing circuitry 28. Although certain operations of the method 380 are presented in a particular order in FIG. 15, it should be understood that additional or fewer operations may be used in a same or different operational order than that presented below. Furthermore, although described herein as performed by the image processing circuitry 28, it should be understood that other circuitry may perform some or all of the operations described herein.

At block 382, the image processing circuitry 28 may receive a frame of image data 74 for display. The frame of image data 74 may be generated by any suitable image frame 74 or image data generation process. The image processing circuitry 28 may generate the image frame based on indications of user inputs, programmed operations, or the like. In certain instances, the image processing circuitry 28 may retrieve the image frames from memory. For example, the image frames may have been previously generated by an image source and stored in memory for access by the image processing circuitry 28.

At block 384, the image processing circuitry 28 may determine an estimated noise based on the frame of image data 74 and a model. The image processing circuitry 28 may convert the image data 74 from gray level to voltage values. The image processing circuitry 28 may reduce the image data 74 into a vector representation of differences between pixel voltage and anode reset voltage to generate a vector representation and input the vector representation into the display noise engine 240 to project the estimated switching DTX. The display noise engine 240 may input the vector representation into a model that includes parameters corresponding to noise generated by each color channel, noise generated per column of the electronic display 12, noise generated per row of the electronic display 12, noise generated based on or more rows and/or one or more columns of the electronic display 12, or any combination thereof. Moreover, the model may estimate the switching DTX per color and/or per touch frequency.

At block 386, the image processing circuitry 28 may transmit the estimated noise to the touch subsystem 30 to enable the touch subsystem 30 to compensate for the estimated noise. The image processing circuitry 28 may send the estimated switching DTX to the touch subsystem 30 to compensate for the switching DTX. For example, the image processing circuitry 28 may generate a computed noise signal indicative of the switching DTX to enable the touch subsystem 30 to compensate for the switching DTX in the touch scan data to improve touch sensing operations. Additionally or alternatively, the image processing circuitry 28 may transmit sync information (e.g., gate clock information and/or additional sync data) to the touch subsystem 30 to enable compensation of the switching DTX.

For example, the touch subsystem 30 may receive touch scan data from the electronic display 12. The touch scan data may include indications of sensing capacitance based on signal interactions between the touch drive electrode and the touch sense electrode during a touch operation. After receiving the touch scan data, the touch subsystem 30 may compensate for switching DTX within the touch scan data based on the computed noise signal. To compensate, the computed noise signal may be subtracted from the touch scan data or otherwise used to compensate for switching DTX.

FIG. 16 illustrates a graph 420 of a magnitude of switching DTX (axis 422) over rows of touch receivers 134 (axis 424). The graph 420 includes a projected switching DTX (illustrates by line 426) and a measured switching DTX (illustrates by line 428). The graph 420 also includes a projection accuracy (illustrates by line 430), which may be a ratio or a difference of the projected switching DTX and the measured switching DTX. The projected switching DTX may be determined by inputting a frame of image data 74 into the model within the display noise engine 240 and the measured switching DTX may be determined by measuring noise generated by displaying the frame of image data 74. As illustrated, the projected switching DTX and the measured DTX may be substantially similar, with an error less than 20%. As such, the described systems and methods may improve touch performance in an integrated image and touch display.

Technical effects include using the described systems and methods to improve touch performance in integrated image and touch display when unwanted parasitic coupling is present in the electrodes shared by the touch subsystem and the display subsystem. These error determination and cancellation systems and methods may be broadly applied to other systems as well, which may include a range of devices like phones, tablets, watches, desktop computers, laptop computers, or the like. By reducing the error contributions from switching DTX based on image data, a demodulation signal, a window function, or any combination thereof, the accuracy and reliability of touch sense data may improve. Furthermore, power consumed by the touch system and/or the touch sensing circuitry in the display may be reduced. The systems and methods may also enable high touch frequency operations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S. C. 112(f). However, for any claims containing elements designated in any other manner, it is intended that such elements are not to be interpreted under 35 U.S. C. 112(f).

What is claimed is:

1. A system comprising:
an electronic display configured to present image data and obtain touch scan data corresponding to at least one touch sense region of the electronic display;
image processing circuitry configured to:
receive the image data to be presented during a touch sensing operation;
determine an estimated display-to-touch noise due to variations of voltage on anodes of display pixels based at least in part on content of the image data; and
transmit the estimated display-to-touch noise to a touch subsystem obtaining the touch scan data to enable the touch subsystem to account for the estimated display-to-touch noise.

2. The system of claim 1, wherein the image processing circuitry is part of a display driver integrated circuit of the electronic display.

3. The system of claim 1, wherein the image processing circuitry is configured to determine the estimated display-to-touch noise based on a model.

4. The system of claim 3, wherein the image processing circuitry is configured to generate a vector representation of the image data to input into the model, wherein the vector representation comprises display pixel anode voltage variations based on the image data.

5. The system of claim 3, wherein the model comprises:
a first matrix of constant values corresponding to each color channel and each row of the electronic display; and
a second matrix of constant values corresponding to clock signal noise.

6. The system of claim 3, wherein the model comprises a lump-summed parameter for determining the estimated display-to-touch noise corresponding to a respective row of the electronic display.

7. The system of claim 6, wherein the image processing circuitry is configured to determine the estimated display-to-touch noise corresponding to the respective row of the electronic display based on the model, a window function, a demodulation function, or any combination thereof.

8. The system of claim 3, wherein the image processing circuitry and the model are part of a system-on-chip.

9. The system of claim 1, wherein the variations of voltage on the anodes is caused by overlap between an anode reset operation implemented by a display driver of the electronic display and the touch sensing operation implemented by the touch subsystem.

10. A system comprising:
an electronic display comprising:
a plurality of display pixels configured to emit light to form a frame of image content;
a touch subsystem comprising a plurality of touch receivers, the touch subsystem configured to:
obtain touch scan data during a touch sensing operation corresponding to at least one touch receiver of the electronic display; and
adjust the touch scan data based on an estimated display-to-touch noise to account for display-to-touch noise; and
image processing circuitry configured to:
receive image data to be presented during the touch sensing operation;
determine the estimated display-to-touch noise due to variations of voltage on anodes of display pixels based at least in part on content of the image data; and
transmit the estimated display-to-touch noise to the touch subsystem to compensate the touch scan data.

11. The system of claim 10, wherein the image processing circuitry is implemented on a display driver integrated circuit of the electronic display.

12. The system of claim 10, wherein the image processing circuitry is implemented on a system-on-chip separate from the electronic display.

13. The system of claim 10, wherein the electronic display is configured to implement an anode reset operation that is partially in phase with the touch sensing operation, and wherein overlap between the anode reset operation causes the variations of voltage on the anodes of the display pixels as sensed in the touch sensing operation.

14. The system of claim 13, wherein the estimated display-to-touch noise comprises a compute noise signal generated by the image processing circuitry to account for the display-to-touch noise.

15. The system of claim 14, wherein the image processing circuitry is configured to generate the compute noise signal based on a model and the image data.

16. A method comprising:
receiving, via image processing circuitry, image data to be presented on an electronic display by display pixels during a touch sensing operation performed by a touch subsystem;
determining, via the image processing circuitry, an estimated display-to-touch noise generated by due to variations of voltage on anodes of the display pixels based at least in part on content of the image data; and
transmitting, via the image processing circuitry, the estimated display-to-touch noise to the touch subsystem to enable the touch subsystem to account for display-to-touch noise.

17. The method of claim 16, wherein the touch subsystem is configured to adjust touch scan data from the touch sensing operation to account for display-to-touch noise generated from the variations of voltage on the anodes of the display pixels using the estimated display-to-touch noise and gate clocking information.

18. The method of claim 16, comprising:
generating, via the image processing circuitry a vector representation of the image data, wherein the vector representation of the image data comprises display pixel anode voltage variations or resulting current changes data based on the image data; and
determining, via the image processing circuitry, the estimated display-to-touch noise based on a model and the vector representation of the image data.

19. The method of claim 16, wherein the estimated display-to-touch noise comprises a computed noise signal.

20. The method of claim 16, comprising transmitting, via the image processing circuitry, gate clocking information to the touch subsystem to adjust touch scan data to account for the display-to-touch noise.
